(19) United States
(12) Patent Application Publication
(10) Pub. No.: US 2023/0071990 A1
(43) Pub. Date: Mar. 9, 2023

(54) WINDER

(71) Applicant: Kevin RENOUF, Auckland (NZ)

(72) Inventor: Bruce John STRACHAN, Auckland (NZ)

(73) Assignee: Kevin RENOUF, Auckland (NZ)

(21) Appl. No.: 17/799,475

(22) PCT Filed: Feb. 10, 2021
(86) PCT No.: PCT/IB2021/051050

§ 371 Date: Aug. 12, 2022

(30) Foreign Application Priority Data
Feb. 13, 2020 (NZ) 761722

(51) Int. Cl. B60P 7/08; B65H 18/10; B65H 75/28

(52) U.S. Cl. CPC B60P 7/0846; B65H 18/10; B65H 75/28; B65H 2701/11332; B65H 2402/42; B65H 2408/234

(57) ABSTRACT

Described is a tiedown winder. It has a base member having a magnetised region to allow the base member to be selectively secured one of a plurality of ferrous parts of a vehicle to become releaseable secured thereto. It also has an axle able, in a use position, to engage with said base member in a manner to allow rotation of the axle relative the base member and presenting a winding zone about which a tie down can be wound.

### FIELD OF INVENTION

The present invention relates to a winder such as for use in winding up tie-downs or strapping that may be used on vehicles to secure loads to a vehicle.

### BACKGROUND

Tie-downs are commonly used in the trucking industry for tying loads down onto a deck of a commercial vehicle. In some instances many tie-downs may be used in securing a load or loads onto the deck of a truck. The tie-downs are made from a webbing material, are elongate and are strong, able to be tensioned and usually anchored at a first tail end and at an end having ratchet tensioner. The tensioner is often incorporated as part of the tie down system and may have an anchor point for securing to the truck so that between the two anchor points a tension can be created in the tie-down for securing a load.

Truck drivers can spend a lot of time winding tie-downs into a coil format for storage, after use. The winding of a tie-down is often done manually and without any tools to coil the tie down about a self-defined core. A truck driver may roll the tie-down about a self-defined core by rolling the tie-down up along the ground or by holding the coil in both hands and causing it to rotate thereby causing an uptake of the remainder of the uncoiled tie-down onto the coil. A coiled tie-down is a tidy and compact format of a tie-down for the purposes of its storage. The truck may have compartments at where coiled tie-downs are stored.

### BRIEF DESCRIPTION OF THE INVENTION

In a first aspect the present invention may be said to be a tiedown winder comprising
a. a base member having a magnetised region to allow the base member to be selectively secured one of a plurality of ferrous parts of a vehicle to become releaseable secured thereto,
b. an axle able, in a use position, to engage with said base member in a manner to allow rotation of the axle relative the base member and presenting a winding zone about which a tie down can be wound,

Preferably the tiedown winder also comprise a crank or means to cause the rotation of the axle.

Preferably the means to cause said rotation is a crank handle protecting from the axle and having a handle region able to be grasped by a person to rotate the axle.

Preferably the axle is able to releasably engage with the base member.

Preferably the means to rotate is integrally formed with the axle.

Preferably the axle presents a slot for a tail of the tiedown to be held to help initiate the initial winding on of the tiedown onto the axle.

Preferably at least part and preferably all of at least one of the axle and means to cause rotation of the axle is/are of a ferrous material to allow the axle and/or the means to cause rotation to be magnetically held to the base member.

Preferably the base and at least one of the axle and means to cause rotation are shaped in a complimentary manner to facilitate registration with the base of the axle in a stored position in a predetermined repeatable manner when the axle is removed from its use position.

Preferably when in the stored position the axle or means to cause rotation is by its magnetic attraction help to the base member in the stored position.

Preferably the magnetised region is provided by at least one magnet secured to base member.

Preferably the magnetised region is provided by at least one magnet embedded in the base member.

Preferably the magnet is of a size and/or magnetic strength to ensure the base member remains secure to the vehicle when the tiedown winder is being used to wind up a tiedown, yet by adult human hand is able to be allow the removal of the tiedown winder from the vehicle.

In a second aspect the present invention may be said to be a tiedown winder comprising
a. a base member having a magnetised region to allow the base member to be secured to a ferrous part of a vehicle to become releaseable secured thereto.
b. an axle journaled or able to be journaled with said base member and presenting a winding zone about which a tie down can be wound, the axle having a feature being or with which a means to rotate the axle about the journal axis can engage to cause the axle to rotate relative the base member and cause the tie down to wind onto the axle and about the axle onto itself into a coil format.

In a further aspect the present invention may be said to be a truck carrying a plurality of tiedowns and at least one tiedown winder as herein before described and therein the truck presents at least 10 locations at where the tiedown winder is able to releasably and magnetically secure for the purposes of sequentially winding a plurality of tiedown each into a coil format.

In a further aspect the present invention may be said to be a method of winding and stowing a plurality of tiedowns each in a coil format the method comprising, taking a tiedown winder as herein before described and magnetically securing it to a ferrous part of a truck, (a) loading a tail end of a first tiedown onto the axle and (b) causing the axle to rotate to thereby wind the tiedown into a coil format about the axle and (c) removing the so coiled tiedown from the axle, thereafter repeating steps (a)-(c) for subsequent tiedowns and then removing the tiedown winder from the truck, stowing the coiled tiedowns.

Preferably the vehicle is a road vehicle.

Preferably the vehicle is a truck or trailer or truck and trailer unit.

Preferably vehicle is a boat or ship or barge.

As used herein the term “and/or” means “and” or “or”, or both.

The term vehicle may mean a land or water based vehicle such as a marine vessel such as a boat or ship or barge.

As used herein “(s)” following a noun means the plural and/or singular forms of the noun.

The term “comprising” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.)

### BRIEF DESCRIPTION OF THE DRAWINGS

FIG. 1 is a perspective view of a commercial vehicle such as a truck with which the winder of the present invention is engaged,

FIG. 2 is a perspective view of the winder of the present invention,

FIG. 3 is an alternative perspective view of the winder of the present invention,

FIG. 4 is a perspective view of the winder of the present invention with a Tie-down coiled onto its axle.

### DETAILED DESCRIPTION

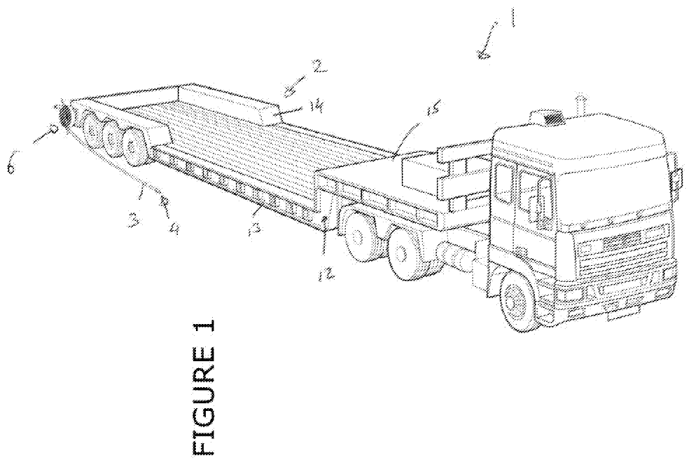

With reference to FIG. 1 there is shown a commercial vehicle 1 such as a truck. The truck may comprise of a flat-bed 2 where a load may be placed and may become secured. The load may be a stack of timber beams, pipes, or many other types of loads commonly carried on a truck.

The load is preferably secured to the truck using a tie-down 3. The tie-down 3 may include a tail end 4 that has an anchor 5 attached to it. The tie-down is preferably of a woven fabric material. The tie-down may be of a webbing material. In some instances, tie-downs may be referred to as “hold-down-straps” or “straps” or the like. They are flexible and of a flat elongate nature. This allows for the tie-down to pass over a load and be anchored at its tail end 4 at one side of the flat bed and by a similar anchor at the other tail end (not shown) of the tie down to the other side of the flat bed. A ratchet tensioning mechanism (not shown) may be incorporated with the tie-down to allow for a person such as the truck driver to tighten the tie-down, create tension in it and apply a hold-down force to the object the tie-down is securing the flat bed to.

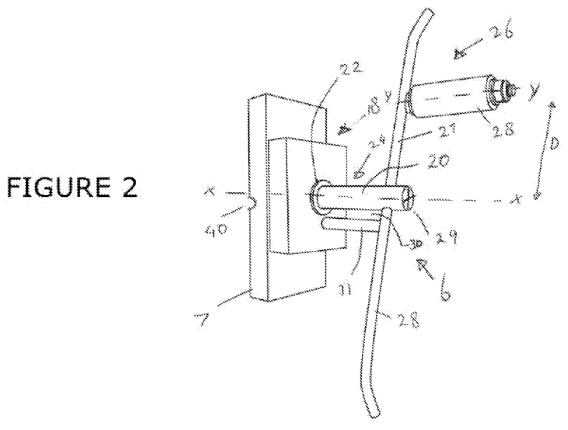

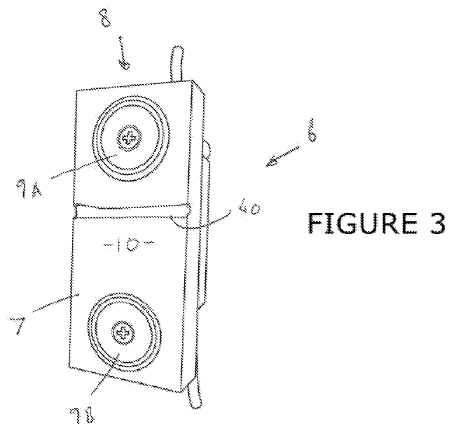

The tie-down winder 6 as seen in more detail in FIGS. 2 and 3 comprises of a base member 7. The base member 7 has a magnetised region 8. Preferably the magnetised region is established by virtue of a magnet or magnets 9A and/or 9B presented at or adjacent the back face 10 of the base member 7. The base member 7 may be a base plate that is of a size sufficient to allow for the tie-down winder to be secured, magnetically, to a ferrous part of the vehicle.

The magnet or magnets 9A/9B are preferably the size and sufficient magnetic strength to secure the base member to for example a steel beam or plate of the flat bed 2. The magnets are preferably positioned and of a size and/or magnetic strength that is sufficient to hold the tie-down winder in place including whilst it is being used to wind up a tie-down, but is not so strong as to prevent the tie-down winder from being removed by a person such as an adult by hand (preferably without the use of any extra tools) from the truck. The tie-down is hence able to be releasably secured to a part of the vehicle.

Given that substantial parts of the vehicle are made from steel, a truck driver is able to choose from one of many available spaces on a truck as to where to locate the tie-down for use. This is a big advantage in terms of speed of use of the winder. The winder does not need to be taken to one or a few dedicated locations on the truck to secure it. And the winder is able to quickly engage most metal parts of the truck without needing to make any adjustments to the winder to so secure it.

In FIG. 1, the tie-down winder 6 is shown to be secured at the tail of the flat bed 2. However, the winder may also be located such as at locations 12, 13, 14 and 15 as examples of where a tie-down winder of the present invention may be secured to the truck. As long as a sufficiently large area with some surrounding clearance is provided, the tie-down winder should be able to be magnetically secured for use.

The base member 7 may have a back face 10 that is substantially planar so that it can locate against a complementary planar surface of the truck. The back face 10 may not be substantially planar but is preferably of a shape that still allows for a stable engagement of the tie-down winder to be established with the truck. A surface that provides at least 3 point contact with the truck is hence desirable for spreading point loads and hence providing a stable, triangulated base engagement with the truck.

The base member 7, preferably on the side 18 opposite the back face 10, is able to receive an axle 20, preferably in a removable manner. The axle may instead be located thereat in a permanent manner. The axle preferably has a rotational axis XX about which the axle is able to rotate relative to the base member 7. The axle 20 is preferably journaled with the base member 7 or may be mounted to the base member 7 with an intermediate bush or bearing 22. The mounting as such is to allow for the axle 20 to be rotated relative to the base member 7.

The axle 20 has a winding zone 24 at where a tie-down is able to be wound.

The axle may include a means to cause the rotation of the axle such as a handle 26. The handle 26 may include a handle shaft 27 and a handle grip 28. Preferably the handle grip 28 is rotatably mounted relative to the handle shaft 27. Preferably the rotational axis YY of the handle grip is parallel to the axis XX. In a preferred form the axis XX extends in a direction normal to the substantially planar surface 10 of the base member. Preferably the handle axle 27 extends perpendicular to and from the axis XX and to the axis YY. The handle grip 28 is offset at a distance D from the axis XX. This allows for the handle 26 to operate in a cranking manner to so cause rotation of the axle 20.

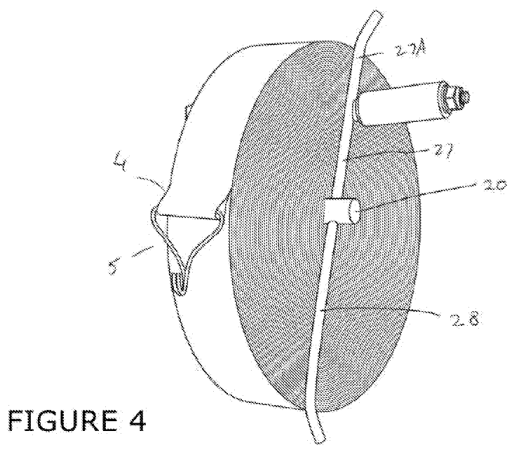

The axle arm 27 may also be provided to help guide the winding of the tie-down into a substantially flat coil. This format of the tie down can be seen in FIG. 4. It can be seen that the handle axle 27, its extension 27A and in the equivalent guide 28, extending in a direction opposite to the handle axle 27 from the axle 20 can help provide a guide to help coil a tie-down in a tidy and flat manner as seen in FIG. 4.

The means to cause the rotation of the axle may, instead of being a handle, be a receptacle 29 at the end of the axle 20 to receive a driver such as a screw driver that may be driven by an electric drill such as a cordless drill. The means to cause rotation of the axle may hence be a drive head receptacle or form with which a driver from a cordless drill may locate and for the cordless drill to then be the primary mover for causing the rotation of the axle via the means to cause rotation 26 that may be integrally formed with the axle 20.

The axle 20 and/or the handle shaft 27 or the handle grip 28 may present a slot 30 at where a tail end of the tie-down is able to register and be held during the initial winding of the tie-down onto the axle. The slot 30 may help trap the tail end and prevent it from free spinning relative to the axle. The slot 30 may be defined between the shaft 20 and a pin 31 that may be secured to the handle grip 28. The slot and/or pin helps with the initial winding on of the tie-down onto the axle and helps grip the tie-down to the axle to prevent the axle from free spinning relative to the tie down.

As mentioned above, the axle is preferably removable from the base member 7. The base member may have a surface relief 40 provided it is where the axle is able to register. The surface relief 40 may be a rebate or slot or channel formed in the surface of base 7 at the back face 10. The rebate 40 is able to receive part of the axle 20 thereat. The handle arm 27 and the handle grip 28 projecting from the axle 20 and across the respective magnets 9A and 9B therefor allows for the axle to be magnetically held in a stored condition to the base member 2. The arm axle 27 and the handle grip 28 may be of a ferrous material to be held against the magnetics 9A and 9B. The slot 40 helps with registering the axle to the base member in such a stored condition. Other shape and configuration detailing between the base member and the axle and/or handle may be provided so as to help hold the components of the winder in a non-use condition relative to each other.

The removal of the axle from the base member may also be needed in order to slip a coiled tiedown off the axle from the end of the axle proximal the base. But in some configurations is envisaged that the tiedowns can slip of the end of the axle distal to the base such as by removing the handle or where the means to cause rotation is a drill driven driver.

1. A tiedown winder comprising
a. a base member having a magnetised region to allow the base member to be selectively secured at one of a plurality of ferrous parts of a vehicle to become releaseable secured thereto,
b. an axle able, in a use position, to engage with said base member in a manner to allow rotation of the axle relative the base member and presenting a winding zone about which a tie down can be wound,
c. a means to cause the rotation of the axle.

2. The tiedown winder as claimed in claim 1 wherein the means to cause said rotation is a crank handle protecting from the axle and having a handle region able to be grasped by a person to rotate the axle.

3. The tiedown winder as claimed in claim 1 wherein the axle is able to releasably engage with the base member.

4. The tiedown winder as claimed in claim 1 wherein the means to rotate is integrally formed with the axle.

5. The tiedown winder as claimed in claim 1 wherein the axle presents a slot for a tail of the tiedown to be held to help initiate the initial winding on of the tiedown onto the axle.

6. The tiedown winder as claimed in claim 1 wherein at least part and preferably all of at least one of the axle and means to cause rotation of the axle is/are of a ferrous material to allow the axle and/or the means to cause rotation to be magnetically held to the base member.

7. The tiedown winder as claimed in claim 1 wherein the base and at least one of the axle and means to cause rotation are shaped in a complimentary manner to facilitate registration with the base of the axle in a stored position in a predetermined repeatable manner when the axle is removed from its use position.

8. The tiedown winder as claimed in claim 7 wherein when in the stored position the axle or means to cause rotation is by its magnetic attraction help to the base member in the stored position.

9. The tiedown winder as claimed in claim 1 wherein the magnetised region is provided by at least one magnet secured to base member.

10. The tiedown winder as claimed in claim 1 wherein the magnetised region is provided by at least one magnet embedded in the base member.

11. The tiedown winder as claimed in claim 9 wherein the magnet is of a size and/or magnetic strength to ensure the base member remains secure to the vehicle when the tiedown winder is being used to wind up a tiedown, yet by adult human hand is able to be allow the removal of the tiedown winder from the vehicle.

12. A tiedown winder comprising
a. a base member having a magnetised region to allow the base member to be secured to a ferrous part of a vehicle to become releaseable secured thereto.
b. an axle journaled or able to be journaled with said base member and presenting a winding zone about which a tie down can be wound, the axle having a feature being or with which a means to rotate the axle about the journal axis can engage to cause the axle to rotate relative the base member and cause the tie down to wind onto the axle and about the axle onto itself into a coil format.

13. A truck carrying a plurality of tiedowns and at least one tiedown winder as claimed in claim 1 and therein the truck presents at least 10 locations at where the tiedown winder is able to releasably and magnetically secure for the purposes of sequentially winding a plurality of tiedown each into a coil format.

14. A method of winding and stowing a plurality of tiedowns each in a coil format the method comprising, taking a tiedown winder as claimed in claim 1 and magnetically securing it to a ferrous part of a vehicle, (a) loading a tail end of a first tiedown onto the axle and (b) causing the axle to rotate to thereby wind the tiedown into a coil format about the axle and (c) removing the so coiled tiedown from the axle, thereafter repeating steps (a)-(c) for subsequent tiedowns and then removing the tiedown winder from the vehicle, stowing the coiled tiedowns on the vehicle.
